(19) United States
(12) Patent Application Publication
(10) Pub. No.: US 2025/0005843 A1
(43) Pub. Date: Jan. 2, 2025

(54) INFORMATION PROCESSING DEVICE AND INFORMATION PROCESSING METHOD

(71) Applicant: SONY GROUP CORPORATION, TOKYO (JP)

(72) Inventors: LEGONG SUN, TOKYO (JP); YUHI KONDO, TOKYO (JP); TAISHI ONO, TOKYO (JP); TEPPEI KURITA, TOKYO (JP)

(21) Appl. No.: 18/710,630

(22) PCT Filed: Oct. 31, 2022
(86) PCT No.: PCT/JP2022/040668

§ 371 Date: May 16, 2024

(30) Foreign Application Priority Data
Nov. 24, 2021 (JP) 2021-189965

(51) Int. Cl. G06T 15/06

(52) U.S. Cl. CPC G06T 15/06

(57) ABSTRACT

An information processing device (100) includes a control unit (130). The control unit (130) sets the number of samples of a light ray used in a case where a rendered image is generated by utilization of ray tracing. The control unit (130) uses the number of samples and generates the rendered image used as training data of machine learning. The control unit (130) adjusts the number of samples according to accuracy of a machine learning model of a case where the rendered image is learned as the training data and the number of samples used in generation of the rendered image.

### FIELD

The present disclosure relates to an information processing device and an information processing method.

### BACKGROUND

In recent years, a method of rendering an image by using ray tracing is known. Ray tracing is a technology of simulating propagation of light rays. For example, by using ray tracing, a rendering device that renders an image can simulate light rays propagated to a certain viewpoint and render an image at this viewpoint.

It has been known that a calculation amount of ray tracing is generally large. Thus, a technology of reducing the calculation amount by executing recalculation with respect to a light ray affected by movement of an object in a case where a moving image is rendered has been known.

### CITATION LIST

### Patent Literature

Patent Literature 1: Japanese Patent Application Laid-Open No. 1-273190

### SUMMARY

### Technical Problem

However, the above-described technology is based on rendering of a moving image. Thus, in the above-described technology, it is difficult to reduce a calculation amount in a case of rendering a plurality of still images of completely different scenes. That is, a method of reducing the calculation amount of ray tracing of one image is not studied in the above-described technology.

Thus, the present disclosure provides a mechanism capable of further reducing a calculation amount in rendering of an image.

Note that the above problem or object is merely one of a plurality of problems or objects that can be solved or achieved by a plurality of embodiments disclosed in the present specification.

### Solution to Problem

An information processing device of the present disclosure includes a control unit. The control unit sets the number of samples of a light ray used in a case where a rendered image is generated by utilization of ray tracing. The control unit uses the number of samples and generates the rendered image used as training data of machine learning. The control unit adjusts the number of samples according to accuracy of a machine learning model of a case where the rendered image is learned as the training data and the number of samples used in generation of the rendered image.

### BRIEF DESCRIPTION OF DRAWINGS

FIG. 1 is a view for describing a schematic configuration example of an information processing device according to a first embodiment of the present disclosure.

FIG. 2 is a view for describing an outline of ray tracing.

FIG. 3 is a view for describing the outline of the ray tracing.

FIG. 4 is a view for describing the outline of the ray tracing.

FIG. 5A is a view illustrating an example of an image rendered with the first number of paths N1.

FIG. 5B is a view illustrating an example of an image rendered with the second number of paths N2.

FIG. 5C is a view illustrating an example of an image rendered with the third number of paths N3.

FIG. 6 is a block diagram illustrating a configuration example of an information processing device according to an embodiment of the present disclosure.

FIG. 7 is a flowchart illustrating a flow of an example of adjustment processing executed by the information processing device according to the first embodiment of the present disclosure.

FIG. 8 is a view for describing a schematic configuration example of an information processing device according to a first modification example of the first embodiment of the present disclosure.

FIG. 9 is a flowchart illustrating a flow of an example of adjustment processing executed by the information processing device according to the first modification example of the first embodiment of the present disclosure.

FIG. 10 is a view for describing a schematic configuration example of an information processing device according to a second embodiment of the present disclosure.

FIG. 11 is a block diagram illustrating a configuration example of the information processing device according to the second embodiment of the present disclosure.

FIG. 12 is a flowchart illustrating a flow of an example of adjustment processing executed by the information processing device according to the second embodiment of the present disclosure.

FIG. 13 is a view for describing a schematic configuration example of an information processing device according to a second modification example of the second embodiment of the present disclosure.

FIG. 14 is a flowchart illustrating a flow of an example of adjustment processing executed by the information processing device according to the second modification example of the second embodiment of the present disclosure.

FIG. 15 is a view for describing a schematic configuration example of an information processing device according to a third embodiment of the present disclosure.

FIG. 16 is a block diagram illustrating a configuration example of an information processing device D according to the embodiment of the present disclosure.

FIG. 17 is a flowchart illustrating a flow of an example of adjustment processing executed by the information processing device according to the third embodiment of the present disclosure.

### DESCRIPTION OF EMBODIMENTS

In the following, embodiments of the present disclosure will be described in detail with reference to the accompanying drawings. Note that the same reference signs are assigned to components having substantially the same functional configuration, and overlapped description is omitted in the present specification and the drawings.

Furthermore, in the present specification and the drawings, similar components of embodiments may be distinguished by assignment of different alphabets after the same reference sign. However, in a case where it is not specifically necessary to distinguish the similar components from each other, the same reference sign is assigned.

Furthermore, although description may be made with specific values in the present specification and the drawings, the values are merely examples and other values may be applied.

Each of one or a plurality of embodiments (including examples and modification examples) described in the following can be performed independently. On the other hand, at least a part of the plurality of embodiments described in the following may be appropriately combined with at least a part of the other embodiments. The plurality of embodiments may include novel features different from each other. Thus, the plurality of embodiments can contribute to solving objects or problems different from each other, and can exhibit effects different from each other.

### 1. First Embodiment

### <1.1. Outline of an Information Processing Device>

An information processing device 100 according to the first embodiment of the present disclosure is a device that generates an image to be used as training data of machine learning (hereinafter, also referred to as a training image). The information processing device 100 according to the present embodiment generates the training image by ray tracing. Note that the ray tracing according to the present disclosure may also include path training.

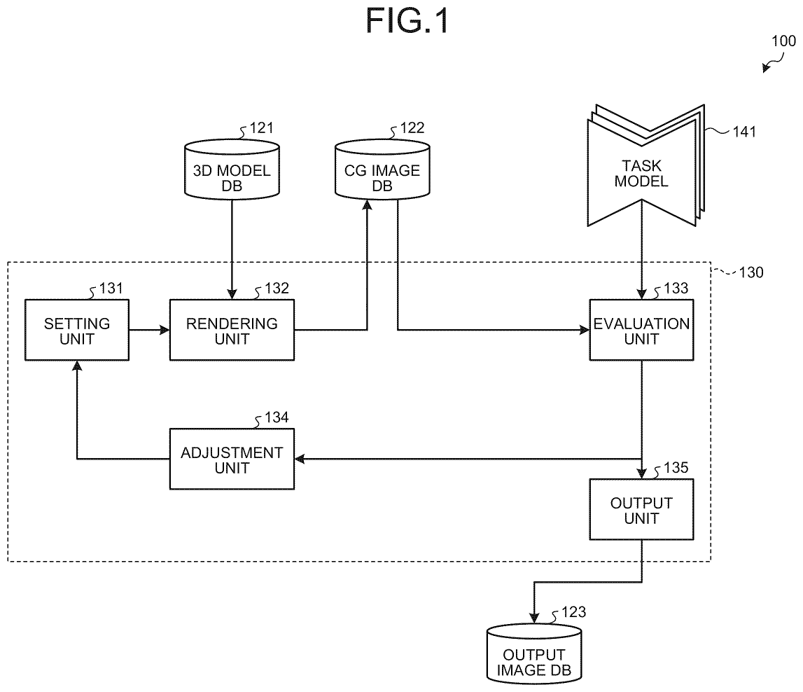

FIG. 1 is a view for describing a schematic configuration example of the information processing device 100 according to the first embodiment of the present disclosure. The information processing device 100 includes a control unit 130, a 3D model data base (DB) 121, a CG image DB 122, and an output image DB 123. The control unit 130 includes a setting unit 131, a rendering unit 132, an evaluation unit 133, an adjustment unit 134, and an output unit 135.

Here, first, rendering of the training image by the rendering unit 132 will be described. As described above, the rendering unit 132 renders the training image by using a ray tracing technology.

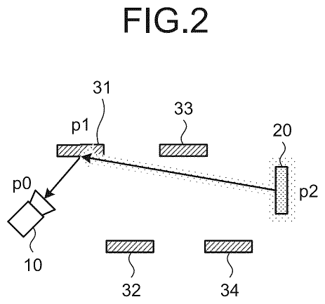

An outline of the ray tracing executed by the information processing device 100 will be described with reference to FIG. 2 to FIG. 4. FIG. 2 to FIG. 4 are views for describing the outline of the ray tracing.

As illustrated in FIG. 2, a light ray (hereinafter, also referred to as a ray) emitted from p2 of a light source 20 is reflected by p1 of an object 31 in a three-dimensional space and reaches a specific pixel p0 of a camera 10.

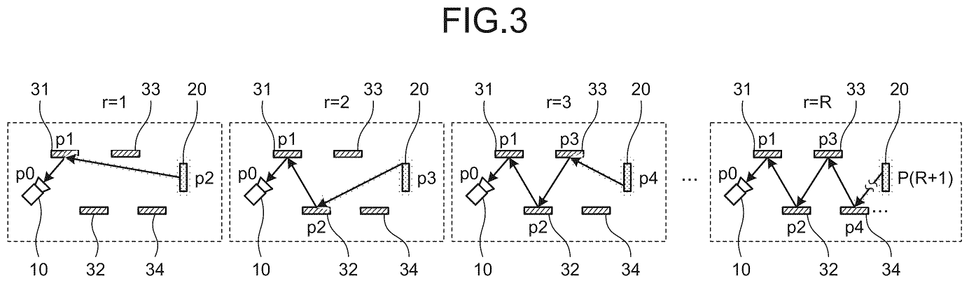

The ray emitted from the light source 20 and reaching the specific pixel p0 of the camera 10 is not limited to the ray illustrated in FIG. 2. For example, a ray indicated by r=2 in FIG. 3 is emitted from p3 of the light source 20, is reflected by p1 of the object 31 and p2 of an object 32, and reaches a specific pixel p0 of the camera 10. In such a manner, the ray emitted from the light source 20 is reflected r times by the objects 31 to 34 (r is a natural number of 0≤r≤R,) and reaches the camera 10 as illustrated in FIG. 3.

In such a manner, the ray reflected once to R times enters the one pixel p0. Hereinafter, tracing the ray that is reflected once to R times and enters the pixel p0 will be referred to as one-path tracing PT or path tracing.

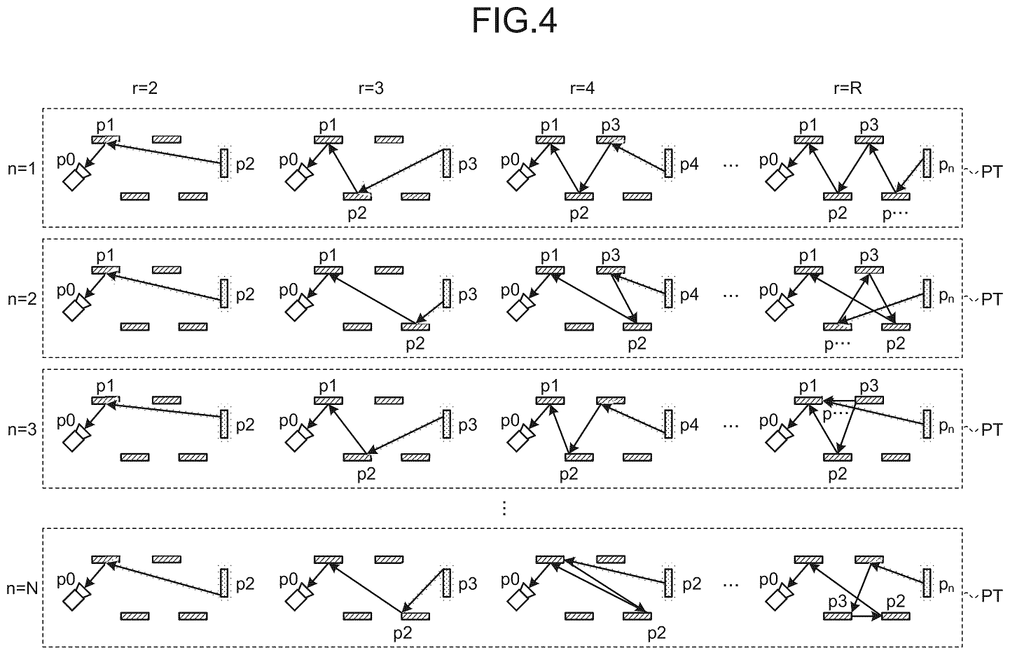

The information processing device 100 calculates the ray that enters the pixel p0 by using a Monte Carlo method. In the example of FIG. 4, the information processing device 100 samples the one-path tracing PT N times and estimates an approximate value (true value) of the ray that enters the pixel p0. Hereinafter, the number of times of sampling N in the one-path tracing PT is also referred to as the number of paths N. As described above, the number of paths (number of times of sampling) N according to the present embodiment is the number of samples in the Monte Carlo method.

The information processing device 100 estimates a true value of path tracing (ray) for each pixel of the camera 10, and generates a computer graphics (CG) image captured from the camera 10 as a training image.

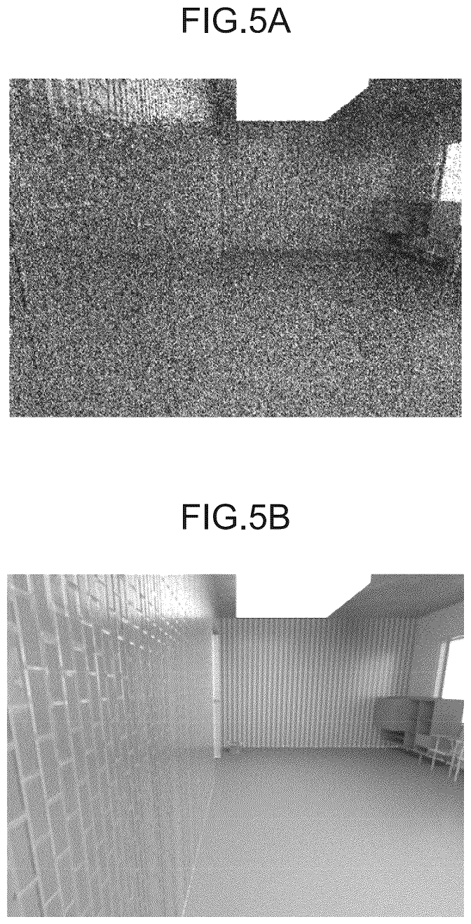

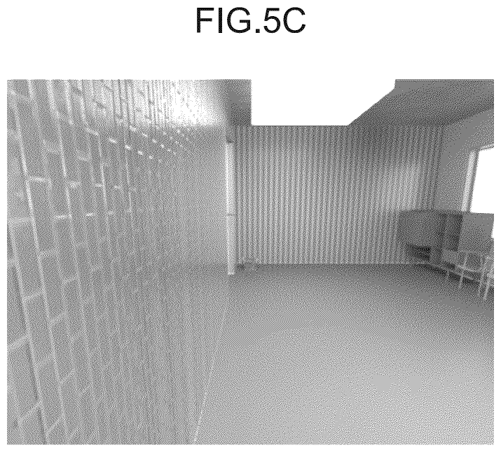

Accuracy of the acquired image varies depending on the number of paths of rendering by the information processing device 100. Here, the accuracy of the image of a case where the information processing device 100 changes the number of paths and renders the image will be described with reference to FIG. 5A to FIG. 5C. Here, it is assumed that the information processing device 100 generates an image including a cabinet.

FIG. 5A is a view illustrating an example of an image rendered with the first number of paths N1. The first number of paths N1 is, for example, N1=1. That is, in a case where the information processing device 100 performs path tracing once for one pixel, an image generated by the information processing device 100 has a large amount of noise and low accuracy as illustrated in FIG. 5A. Thus, it is difficult to know where the cabinet is arranged in the image.

On the other hand, in this case, the calculation amount of the information processing device 100 is very small. That is, the information processing device 100 can generate the image in a short time.

FIG. 5B is a view illustrating an example of an image rendered with the second number of paths N2. The second number of paths N2 is, for example, N2=300. That is, in a case where the information processing device 100 performs the path tracing 300 times for one pixel, the information processing device 100 generates an image in which some noises remain as illustrated in FIG. 5B. Although some noises remain in the image illustrated in FIG. 5B, the image is more accurate than the image illustrated in FIG. 5A.

As described above, the image illustrated in FIG. 5B is an image having accuracy with which it can be understood that the cabinet is arranged on a rear right side. In this case, the calculation amount of the information processing device 100 increases as compared with a case where the image in FIG. 5A is generated.

FIG. 5C is a view illustrating an example of an image rendered with the third number of paths N3. The third number of paths N3 is, for example, N3=20,000. In other words, in a case where the information processing device 100 performs the path tracing 20,000 times for one pixel, the information processing device 100 generates a highly accurate image with little noise as illustrated in FIG. 5C. On the other hand, in this case, the calculation amount of the information processing device 100 becomes very large, and image generation takes a very long time.

As described above, in the rendering using the ray tracing, there is a trade-off relationship between the image accuracy and the calculation amount. For example, in a case where a highly accurate image such as a movie is required, the information processing device can generate a clearer image by increasing the number of paths although the calculation amount increases.

However, as described above, the information processing device 100 according to the present embodiment generates an image to be used as training data of machine learning. In such a manner, in a case where the image is used as the training data, an image with high accuracy is not necessarily required in some cases. For example, depending on performance (accuracy) required for a task of machine learning, there is a case where learning can be performed without a problem even with an image in which some noise remains (see FIG. 5B).

In a case where the information processing device 100 generates the training image, it is desired that the information processing device 100 generates the training image with the smaller number of paths while satisfying the performance required for the task of the learning. As described above, by reducing the number of paths, the information processing device 100 can further reduce the calculation amount in image rendering.

Here, as a method of reducing the number of paths, a method in which a person sets the number of paths can be considered. For example, a method in which the person manually sets the number of paths according to an empirical rule, or a method in which the number of paths is set by visual observation of a training image can be considered.

However, the method of manually setting the number of paths has a problem that a degree of difficulty of the setting is high and a burden on the person is large. For example, in a case of performing the manual setting, the person needs to set the number of paths in consideration of scene contents of the training image, task contents, performance required for the task, and the like, and it is difficult to determine the setting. In addition, in order to set an appropriate value as the number of paths, it is necessary for the person to repeatedly perform the setting through trial and error, and a burden on the person is large.

Thus, in the present embodiment, the information processing device 100 is made to be able to automatically adjust the number of paths. Specifically, the information processing device 100 sets the number of paths N (example of the number of samples) of a light ray (ray) to be used in a case where the training image (example of a rendered image) is generated by utilization of the ray tracing. The information processing device 100 uses the number of paths N and generates the training image to be used as the training data for the machine learning. The information processing device 100 adjusts the number of paths N according to accuracy of a machine learning model of a case where the training image is learned as the training data and the number of samples used to generate the training image.

As a result, the information processing device 100 can automatically set the number of paths (number of samples). The information processing device 100 can further reduce the calculation amount of the rendering by generating the training image of the adjusted number of samples. Furthermore, by adjusting the number of paths N according to the accuracy of the machine learning model, the information processing device 100 can reduce the calculation amount of the rendering without lowering the accuracy of the machine learning model.

Note that the information processing device 100 calculates light rays having the different number of times of reflection r in the one-path tracing PT (see FIG. 3). The maximum value R of the number of times of reflection r at this time is, for example, about 10 to 30. That is, the information processing device 100 traces the light rays about 10 to 30 times by the one-path tracing PT. Thus, the calculation amount of the one path tracing is small. Thus, reducing the number of paths N of the one-path tracing PT greatly contributes to reduction in the calculation amount of the entire ray tracing rather than reducing the calculation amount of one path training.

As described above, the information processing device 100 illustrated in FIG. 1 includes the setting unit 131, the rendering unit 132, the evaluation unit 133, the adjustment unit 134, the output unit 135, the 3D model data base (DB) 121, the CG image DB 122, and the output image DB 123.

The setting unit 131 sets the number of paths N of when the training image is rendered by utilization of the ray tracing. The rendering unit 132 performs the path tracing N times on the basis of the 3D model information of the object, which information is held by the 3D model DB 121, and generates the training image. For example, the rendering unit 132 stores the generated training image in the CG image DB 122.

Here, the 3D model DB 121 is a database that stores information related to the object and used for the rendering. The CG image DB 122 is a database that stores the training image rendered by the rendering unit 132.

For example, the evaluation unit 133 evaluates whether the training image generated by the rendering unit 132 satisfies task performance of the machine learning. In the present embodiment, the evaluation unit 133 evaluates the training image by using a task model 141 learned in advance.

For example, the evaluation unit 133 inputs the training image to the learned task model 141, and evaluates whether the training image satisfies the performance of the task (accuracy of the machine learning model) according to the acquired result.

For example, the evaluation unit 133 inputs the training image to the learned task model 141, and evaluates that the training image satisfies the performance of the task when a desired result is acquired. For example, it is assumed that the task of the machine learning is “detection of a cabinet”. In this case, in a case where the training image is input to the learned task model 141 and the cabinet can be detected, the evaluation unit 133 evaluates that the training image satisfies the performance of the task.

On the other hand, for example, in a case where the training image is input to the learned task model 141 and a desired result cannot be acquired, the evaluation unit 133 evaluates that the training image does not satisfy the performance of the task. For example, in a case where the training image is input to the learned task model 141 and the cabinet cannot be detected, the evaluation unit 133 evaluates that the training image does not satisfy the performance of the task.

The evaluation unit 133 outputs an evaluation result to the adjustment unit 134 and the output unit 135.

The adjustment unit 134 adjusts the number of paths N on the basis of the evaluation result by the evaluation unit 133. That is, the adjustment unit 134 adjusts the number of paths N on the basis of the performance (accuracy) of the task performed by utilization of the training image. For example, in a case where the training image satisfies the performance of the task, the adjustment unit 134 reduces the number of paths N. On the other hand, in a case where the training image does not satisfy the performance of the task, the adjustment unit 134 increases the number of paths N.

The adjustment unit 134 outputs the adjusted number of paths N to the setting unit 131. The setting unit 131 sets the adjusted number of paths N to the number of paths N used for the rendering. For example, the information processing device 100 repeatedly executes adjustment of the number of paths by the control unit 130 until the number of paths N satisfying the performance of the task converges to a predetermined value.

For example, the output unit 135 outputs the training image satisfying the performance of the task as a training image for an output, and performs storing thereof into the output image DB 123.

Note that the evaluation unit 133 may evaluate one task or a plurality of tasks. For example, the evaluation unit 133 may evaluate whether the training image satisfies performance of a task of “detecting depth” in addition to the task of “detecting the cabinet” described above.

Here, the training image satisfying the performance of the task (accuracy of the machine learning model) means that the task model generated by the learning using the training image satisfies desired accuracy. That is, for example, in a case where the training image satisfies the performance of the task of “detecting the cabinet”, the information processing device 100 can generate the task model that detects the cabinet from the input image with desired accuracy by using the training image.

As described above, the information processing device 100 according to the present embodiment adjusts the number of paths N on the basis of scene contents of the training image or the performance of the task. As a result, the information processing device 100 can set the smaller number of paths N while satisfying the learning performance. For example, the information processing device 100 can set the minimum number of paths N that satisfies the accuracy of the machine learning model.

Furthermore, the information processing device 100 adjusts the number of paths N on the basis of the evaluation result of the task model. As a result, the information processing device 100 can automatically adjust the number of paths N without a person.

Furthermore, the information processing device 100 can generate the training image with the smaller number of paths N that satisfy the learning performance. As a result, the information processing device 100 can further reduce the processing amount required for generation of the training image. Specifically, tens of thousands to hundreds of thousands of images are used as training data in the machine learning. Thus, by further reducing the processing amount required for generation of one image, it is possible to greatly reduce the processing amount required for generation of the training data.

### <1.2. Configuration Example of the Information Processing Device>

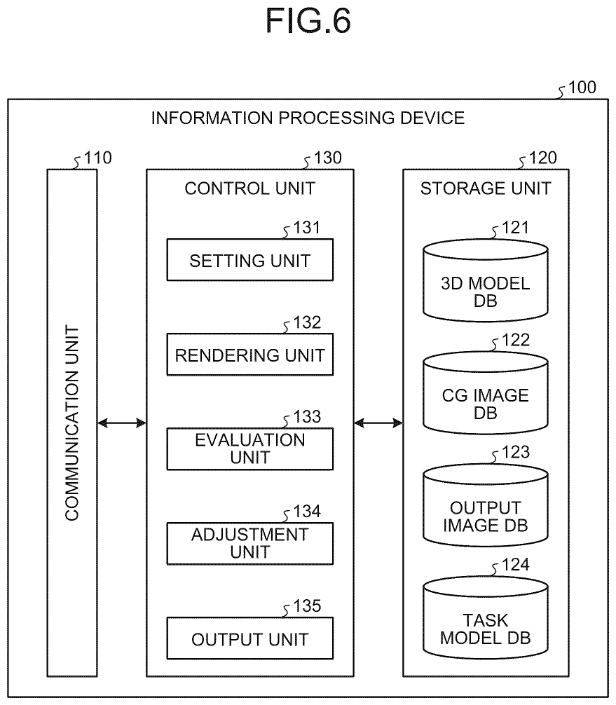

Next, a configuration example of the information processing device 100 according to the first embodiment of the present disclosure will be described. FIG. 6 is a block diagram illustrating the configuration example of the information processing device 100 according to the embodiment of the present disclosure. As illustrated in FIG. 6, the information processing device 100 includes a communication unit 110, a storage unit 120, and the control unit 130.

### [Communication Unit 110]

The communication unit 110 is a communication interface that communicates with an external device via a network in a wired or wireless manner. The communication unit 110 is realized, for example, by a network interface card (NIC) or the like.

### [Storage Unit 120]

The storage unit 120 is a data readable/writable storage device such as a DRAM, an SRAM, a flash memory, or a hard disk. The storage unit 120 functions as a storage means of the information processing device 100.

The storage unit 120 includes the 3D model DB 121, the CG image DB 122, the output image DB 123, and a task model DB 124.

### (3D Model DB 121)

The 3D model DB 121 is, for example, a database that stores various types of material data (3D CD assets) used for generation of the training image, such as model data of three-dimensional CG. The data stored in the 3D model DB 121 is general material data used for rendering of an image.

The 3D model DB 121 stores, for example, model data related to a shape and material of a 3D model, light source data related to the light source 20, camera data related to the camera 10, and the like.

The 3D model DB 121 stores, as the model data related to a shape, format data for three-dimensional mesh representation, such as general data in an obj file format or data in an fbx file format, for example. The 3D model DB 121 stores, as the model data related to a material, format data for representing a CG material, such as data in an mtl file format or a texture image, for example.

The 3D model DB 121 stores, for example, parameters such as a position, direction, color, and shape of the light source 20 as the light source data. The 3D model DB 121 stores, as the camera data, an external parameter, an internal parameter, a lens parameter, and the like of the camera 10.

### (CG Image DB 122)

The CG image DB 122 is a database that stores the training image rendered by the rendering unit 132.

### (Output Image DB 123)

The output image DB 123 is a database that stores the training image. The output image DB 123 stores the training image output from the output unit 135. The output image DB 123 stores, for example, the training image rendered with the smaller number of paths N that achieves a target value (target accuracy) in the performance of the task model 141.

### (Task Model DB 124)

The task model DB 124 is a database that stores the task model 141 learned by the machine learning. It is assumed that the task model DB 124 according to the present embodiment stores the task model 141 learned in advance.

The task model 141 is, for example, a model generated by supervised machine learning according to a task such as object detection or depth detection. For example, in a case where the task model 141 is a convolutional neural network (CNN), the task model DB 124 stores information related to a configuration and weight of the neural network as the task model 141. As the task model 141, for example, in addition to the CNN described above, various network configurations such as a deep neural network (DNN), a recurrent neural network (RNN), and a generic adversarial network (GAN) may be employed.

A plurality of the task models 141 corresponding to the tasks can be stored in the task model DB 124. Different network configurations may be employed, or the same network configuration may be employed for the plurality of task models 141 of different tasks.

In addition, the task model DB 124 stores a target performance value of the task model 141 in association with the task model 141. The target performance value is a value used for evaluation of the task model 141 by the evaluation unit 133 described later. It is assumed that the target performance value is set in advance.

### [Control Unit 130]

The control unit 130 controls each unit of the information processing device 100. The control unit 130 is realized by, for example, a central processing unit (CPU), a micro processing unit (MPU), a graphics processing unit (GPU), or the like executing a program stored inside the information processing device 100 with a random access memory (RAM) or the like as a work area. Furthermore, the control unit 130 is realized by, for example, an integrated circuit such as an application specific integrated circuit (ASIC) or a field programmable gate array (FPGA).

The control unit 130 includes a setting unit 131, a rendering unit 132, an evaluation unit 133, an adjustment unit 134, and an output unit 135. Each block (setting unit 131 to output unit 135) included in the control unit 130 is a functional block indicating a function of the control unit 130. These functional blocks may be software blocks or hardware blocks. For example, each of the above-described functional blocks may be one software module realized by software (including a microprogram), or may be one circuit block on a semiconductor chip (die). Obviously, each of the functional blocks may be one processor or one integrated circuit. The control unit 130 may be configured in units of functions different from the above-described functional blocks. A configuration method of the functional blocks is arbitrary.

Note that the control unit 130 may be configured in units of functions different from the above-described functional blocks. In addition, a part or all of operations of the blocks (setting unit 131 to output unit 135) included in the control unit 130 may be performed by another device. For example, a part or all of the operations of the blocks included in the control unit 130 may be performed by a control device realized by cloud computing.

### (Setting Unit 131)

The setting unit 131 sets the number of paths N of the light ray traced by the rendering unit 132. For example, in a case where an adjustment amount A is not received from the adjustment unit 134, such as a case where the number of paths N is set for the first time, the setting unit 131 sets a predetermined value (default initial value) as the number of paths N. Note that in consideration of the processing amount in the rendering unit 132, the initial value is preferably a small value (for example, around N=16).

For example, in a case where the setting of the number of paths N is a second time or more and the adjustment amount A is received from the adjustment unit 134, the setting unit 131 sets the number of paths N on the basis of the adjustment amount A.

For example, in a case where the adjustment amount A is an increase by 10 (A=+10), the setting unit 131 sets the number of paths, which is acquired by the increase of the previously-set number of paths N by 10, as the present number of paths N (N←N+10). For example, in a case where the adjustment amount A is a decrease by 10 (A=−10), the setting unit 131 sets the number of paths, which is acquired by subtraction of 10 from the previously-set number of paths N, as the present number of paths N (N←N−10).

Note that in a case where the adjustment amount A is the number of paths to be set next, the setting unit 131 sets the adjustment amount A as the present number of paths N (N←A).

As described later, the rendering unit 132 may render a plurality of training images. The setting unit 131 may set the same number of paths N for all of the plurality of training images, or may set different number of paths N. The setting unit 131 may divide the plurality of training images into groups according to scene contents or the like, and set the number of paths N for each of the groups.

In addition, the setting unit 131 sets the same number of paths N for all pixels in one training image. Alternatively, the setting unit 131 may set the different number of paths N for each pixel in one training image. The setting unit 131 may divide the training image into a plurality of regions according to scene contents, an object included in the training image, and the like, and set the number of paths N for pixels included in each region.

The setting unit 131 outputs the set number of paths N to the rendering unit 132.

### (Rendering Unit 132)

The rendering unit 132 renders the training image by the ray tracing by using, for example, various kinds of data related to the 3D model and the number of paths N. For example, the rendering unit 132 acquires various kinds of data from the 3D model DB 121. For example, the rendering unit 132 acquires the number of paths N from the setting unit 131.

The rendering unit 132 may generate, for example, a plurality of the training images. For example, the rendering unit 132 may assign label information indicating Ground Truth to the training image. For example, the rendering unit 132 stores the training image to which the label information is assigned in the CG image DB 122.

### (Evaluation Unit 133)

The evaluation unit 133 evaluates the performance of the task model 141 by using, for example, the training image generated by the rendering unit 132.

The evaluation unit 133 acquires the training image from the CG image DB 122. The evaluation unit 133 acquires the task model 141 from the task model DB 124. The evaluation unit 133 uses the training image as evaluation data, and evaluates the performance of the task model 141.

For example, the evaluation unit 133 evaluates the performance of the task model 141 by calculating a general performance evaluation index. The evaluation unit 133 may evaluate the performance of the task model 141 by using an index such as a mean squared error (MSE), precision, recall, an F-measure, or mean average precision (mAP).

Note that in the case of evaluating the plurality of task models 141, the evaluation unit 133 may perform the evaluation by using the same index for all of the plurality of task models 141, or may perform the evaluation by using different indexes respectively for the task models 141.

For example, the evaluation unit 133 evaluates the performance of the task model 141 by using the plurality of training images, and outputs evaluation results to the adjustment unit 134. The evaluation unit 133 may output evaluation results in various forms.

For example, the evaluation unit 133 outputs, as the evaluation result, a statistical value such as an average or variance of the evaluation results acquired by utilization of all the training images (calculation results of the index). For example, the evaluation unit 133 directly outputs, as vectors, the evaluation results acquired by utilization of all the training images. For example, the evaluation unit 133 outputs, as the evaluation results, difference between the evaluation results acquired by utilization of all the training images and the performance target value. For example, the evaluation unit 133 may output combinations of the training images and the evaluation results. Alternatively, instead of the training images, the evaluation unit 133 may output combination of feature information indicating features of the training images and the evaluation results.

In a case where the evaluation result achieves the target performance set in advance or in a case where the number of times of evaluation reaches the maximum number of times of evaluation, the evaluation unit 133 ends the adjustment of the number of paths N and notifies the output unit 135 to perform final output.

### (Adjustment Unit 134)

For example, the adjustment unit 134 predicts the adjustment amount A of the number of paths N according to the evaluation result of the evaluation unit 133. The adjustment unit 134 may determine one adjustment amount A for all of the plurality of training images, or may determine the adjustment amount A for each of the plurality of training images. The adjustment unit 134 may divide the plurality of training images into groups according to scene contents or the like, and determine the adjustment amount A for each of the groups.

In addition, the adjustment unit 134 determines the same adjustment amount A for all pixels in one training image. Alternatively, the adjustment unit 134 may determine different adjustment amounts A respectively for pixels in one training image. The adjustment unit 134 may divide the training image into a plurality of regions according to scene contents, an object included in the training image, and the like, and determine the adjustment amount A for pixels included in each of the regions.

The adjustment unit 134 determines the adjustment amount A according to the unit in which the setting unit 131 sets the number of paths N (such as each pixel or image).

For example, the adjustment unit 134 may determine the adjustment amount A to increase the number of paths N until the task model 141 satisfies the target performance. An increase amount of the number of paths N by the adjustment unit 134 may be a constant value. That is, the adjustment unit 134 determines the adjustment amount A in such a manner that the number of paths N increases by a constant amount until the task model 141 satisfies the target performance.

The increase amount of the number of paths N by the adjustment unit 134 may be determined according to the number of times of adjustment of the number of paths N. For example, the adjustment unit 134 determines the adjustment amount A in such a manner that the increase amount of the number of paths N decreases as the number of times of adjustment increases. Alternatively, the adjustment unit 134 may determine the adjustment amount A in such a manner that the increase amount of the number of paths N increases as the number of times of adjustment increases.

The increase amount of the number of paths N by the adjustment unit 134 may be determined according to a difference between the evaluation result of the task model 141 and the target performance value. For example, the adjustment unit 134 determines the adjustment amount A in such a manner that the increase amount of the number of paths N increases as the difference between the evaluation result of the task model 141 and the target performance value becomes larger.

Furthermore, the adjustment unit 134 may determine the increase amount of the number of paths N according to the evaluation results of the entire plurality of training images. Alternatively, the adjustment unit 134 may determine the increase amount for each of the plurality of training images according to the evaluation result of each of the plurality of training images. Furthermore, the adjustment unit 134 may change the number of times of adjustment of the number of paths N for every plurality of training images.

Note that although it is assumed herein that the adjustment unit 134 adjusts, by performing the adjustment in such a manner as to increase the number of paths N, the number of paths N in such a manner that the number of paths N becomes smaller while the performance of the task model 141 is satisfied, this is not a limitation. For example, the adjustment unit 134 may determine the adjustment amount A of the number of paths N by using the bisection method, the gradient method, a preset function, or the like.

The adjustment unit 134 outputs the adjustment amount A to the setting unit 131.

### (Output Unit 135)

The output unit 135 outputs the training image as a final output on the basis of an instruction from the evaluation unit 133, for example. Here, the training image output from the output unit 135 is the number of paths N set when the evaluation unit 133 determines to end the adjustment of the number of paths N (hereinafter, also referred to as the final number of paths N). The final number of paths N is, for example, the number of paths N satisfying the performance of the task model 141, and is the number of paths N having a smaller value.

For example, by storing the training image rendered by the rendering unit 132 with the final number of paths N (hereinafter, also referred to as a final training image) in the output image DB 123 as output data, the output unit 135 outputs the final training image. The output unit 135 acquires the final training image from the CG image DB 122, for example.

### <1.3. Adjustment Processing>

Next, adjustment processing executed by the information processing device 100 according to the first embodiment of the present disclosure will be described.

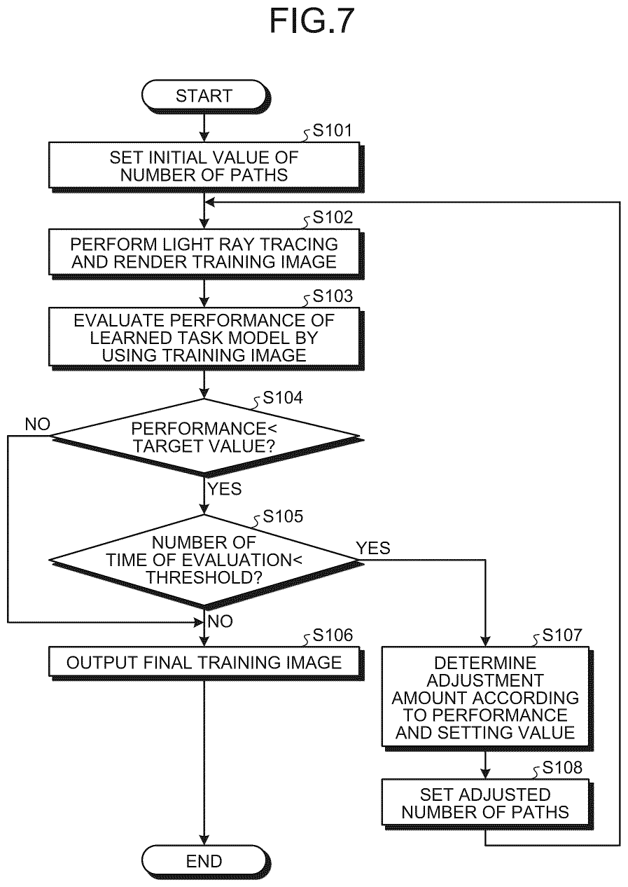

The information processing device 100 executes adjustment processing of adjusting the number of paths N of the rendering, and acquiring the final training image. FIG. 7 is a flowchart illustrating a flow of an example of the adjustment processing executed by the information processing device 100 according to the first embodiment of the present disclosure.

As illustrated in FIG. 7, the information processing device 100 sets an initial value of the number of paths N (such as N=16) (Step S101). The information processing device 100 performs light ray tracing with the set number of paths N and renders the training image (Step S102).

The information processing device 100 uses the training image generated in Step S102 and evaluates the performance of the learned task model 141 (Step S103). The information processing device 100 determines whether the evaluated performance is smaller than the target value (Step S104).

In a case where the performance is equal to or larger than the target value (Step S104; No), the information processing device 100 proceeds to Step S106. On the other hand, in a case where the performance is smaller than the target value (Step S104; Yes), the information processing device 100 determines whether the number of times of evaluation is smaller than a threshold (Step S105). Note that the number of times of evaluation is the same as the above-described number of times of adjustments.

In a case where the number of times of evaluation is equal to or larger than the threshold (Step S105; No), the information processing device 100 outputs the final training image and ends the processing (Step S106). On the other hand, in a case where the number of times of evaluation is smaller than the threshold (Step S105; Yes), the information processing device 100 determines the adjustment amount A according to the performance and the number of paths N (Step S107).

The information processing device 100 adjusts the number of paths N on the basis of the adjustment amount A and sets the adjusted number of paths N (Step S108), and returns to Step S102.

### 2. First Modification Example

### <2.1. Outline of an Information Processing Device>

Although the information processing device 100 adjusts the number of paths N by, for example, a predetermined increase amount in the first embodiment described above, the this is not a limitation. For example, the information processing device 100 may adjust the number of paths N on the basis of machine learning.

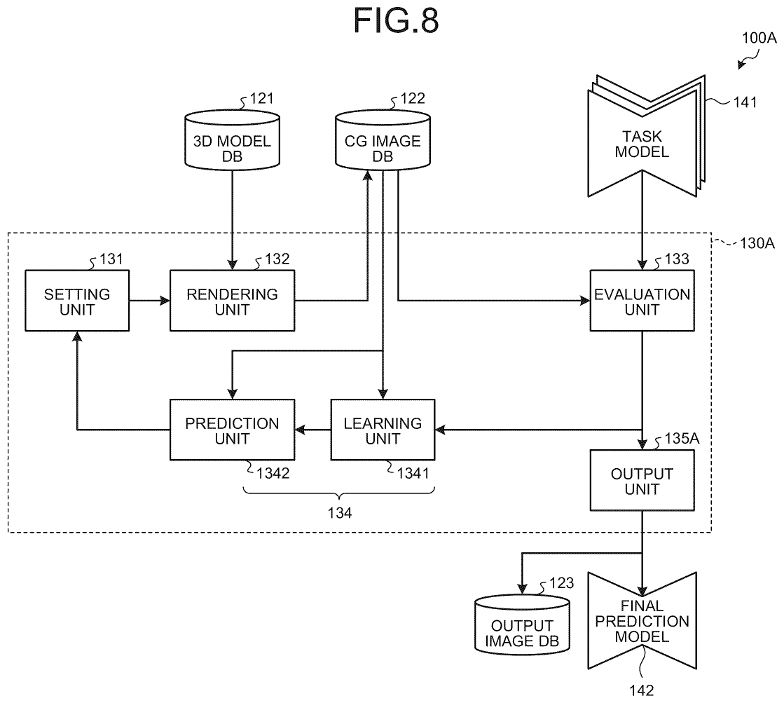

FIG. 8 is a view for describing a schematic configuration example of an information processing device 100A according to the first modification example of the first embodiment of the present disclosure. The information processing device 100A in FIG. 8 is different from the information processing device 100 illustrated in FIG. 1 in a point that an adjustment unit 134 of a control unit 130A includes a learning unit 1341 and a prediction unit 1342, and that the control unit 130A includes an output unit 135A instead of the output unit 135.

The learning unit 1341 performs machine learning by using an evaluation result of an evaluation unit 133 and a training image, and generates a prediction model that predicts the number of paths N. The learning unit 1341 generates a prediction model that predicts the smaller number of paths N that satisfies performance of a task model 141.

In a case where the prediction model is a CNN, the learning unit 1341 calculates information related to a configuration and weight of the neural network. As the prediction model, for example, in addition to the CNN described above, various network configurations such as a deep neural network (DNN), a recurrent neural network (RNN), and a generic adversarial network (GAN) may be employed.

The learning unit 1341 may generate one prediction model for all of a plurality of training images, or may generate the prediction model for each of the training images. The learning unit 1341 may generate the prediction model for each pixel of the training image. For example, the learning unit 1341 may generate the prediction model in units of setting the number of paths N (alternatively, units of determining an adjustment amount A). Alternatively, the learning unit 1341 may generate one prediction model with a plurality of kinds of the number of paths N (or a plurality of the adjustment amounts A).

The learning unit 1341 outputs the prediction model after learning convergence to the prediction unit 1342. In addition, the learning unit 1341 stores the prediction model after the learning convergence in a storage unit 120.

The prediction unit 1342 predicts the number of paths N to be set next by using the prediction model learned by the learning unit 1341. For example, the prediction unit 1342 outputs the number of paths N of the prediction result to the setting unit 131 as the adjustment amount A.

Note that although it is assumed herein that the prediction unit 1342 predicts the number of paths N to be set next, this is not a limitation. For example, the prediction unit 1342 may predict an increase amount (or subtraction amount) of the number of paths N. In this case, the learning unit 1341 learns and generates the prediction model of predicting the increase amount (or subtraction amount) of the number of paths N.

For example, the output unit 135A outputs a final training image and a final prediction model 142 as final output on the basis of an instruction from the evaluation unit 133. The final prediction model 142 is, for example, a prediction model generated by the learning unit 1341 at a time point at which the evaluation unit 133 determines to perform the final output.

For example, every time the number of paths N is set, the learning unit 1341 relearns the prediction model on the basis of a training image rendered by utilization of the number of paths N and the evaluation result of the training image. The learning unit 1341 outputs the repeatedly relearned prediction model to the prediction unit 1342 and performs storing thereof in the storage unit 120. The output unit 135A outputs the latest prediction model stored in the storage unit 120 as the final prediction model 142.

### <2.2. Adjustment Processing>

Next, adjustment processing executed by the information processing device 100A according to the first modification example of the first embodiment of the present disclosure will be described.

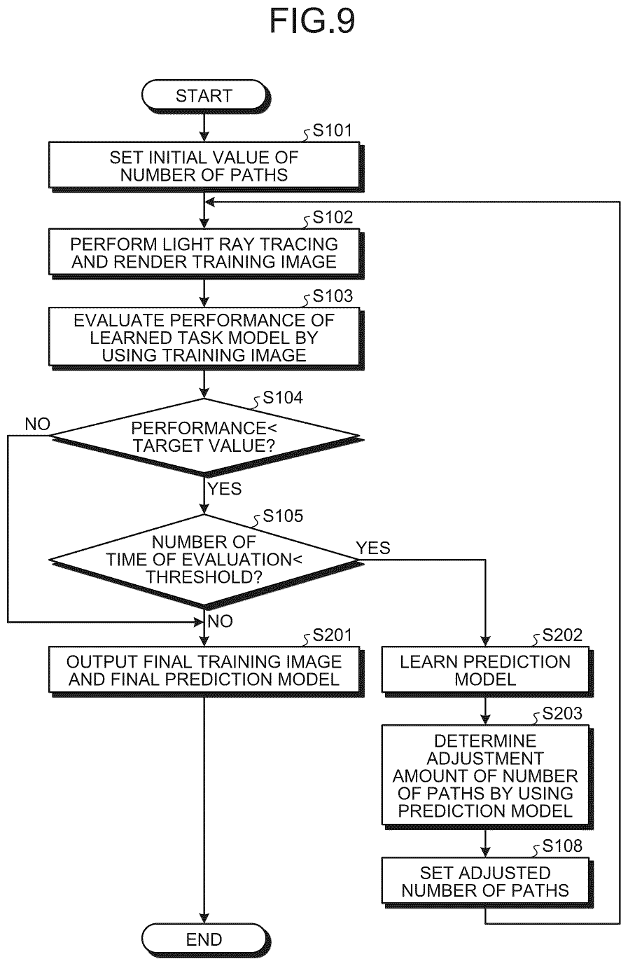

The information processing device 100A adjusts the number of paths N of rendering, and executes the adjustment processing of acquiring the final training image and the final prediction model 142. FIG. 9 is a flowchart illustrating a flow of an example of the adjustment processing executed by the information processing device 100A according to the first modification example of the first embodiment of the present disclosure. Among pieces of the processing illustrated in FIG. 9, the same processing as that in FIG. 7 is denoted by the same reference sign, and description thereof is omitted.

As illustrated in FIG. 9, the information processing device 100A that determines in Step S104 that performance is equal to or greater than a target value or determines in Step S105 that the number of times of evaluation is equal to or larger than a threshold outputs the final training image and the final prediction model 142, and ends the processing (Step S201).

On the other hand, the information processing device 100A that determines in Step S105 that the number of times of evaluation is smaller than the threshold learns the prediction model on the basis of the training image and the evaluation result in Step S103 (Step S202). The information processing device 100 determines the adjustment amount A of the number of paths N by using the learned prediction model (Step S203).

As described above, the information processing device 100A can predict the adjustment amount A by using machine learning by generating the prediction model that predicts the adjustment amount A.

### 3. Second Embodiment

### <3.1. Outline of an Information Processing Device>

Although it has been assumed in the first embodiment described above that the information processing device 100 evaluates the task model 141 by using the task model 141 learned in advance and adjusts the number of paths N, this is not a limitation. For example, the information processing device 100 may learn the task model 141 on the basis of machine learning.

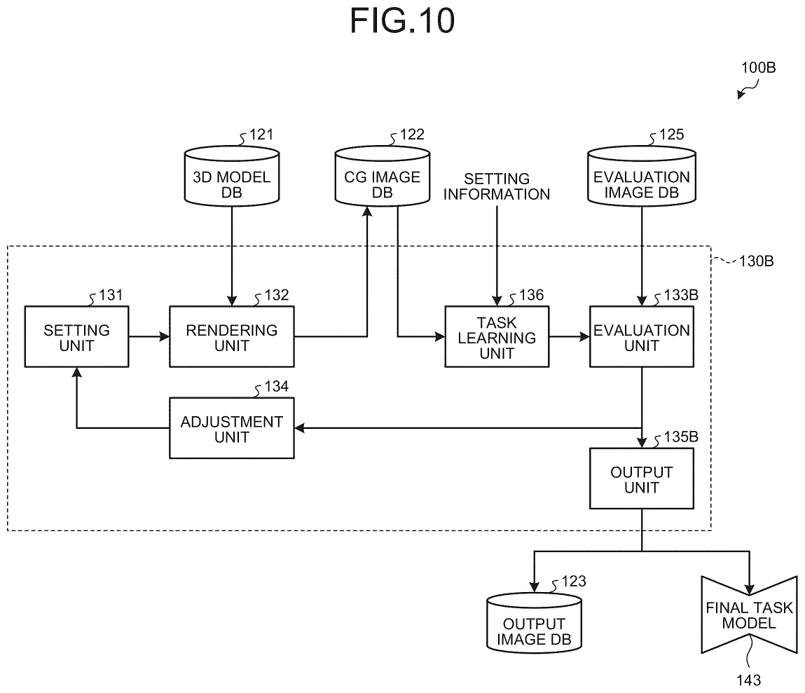

FIG. 10 is a view for describing a schematic configuration example of an information processing device 100B according to the second embodiment of the present disclosure. The information processing device 100B in FIG. 10 is different from the information processing device 100 illustrated in FIG. 1 in a point that a control unit 130B further includes a task learning unit 136. Furthermore, the information processing device 100B in FIG. 10 is different from the information processing device 100 illustrated in FIG. 1 in a point that the control unit 130B includes an evaluation unit 133B and an output unit 135B.

The task learning unit 136 performs machine learning by using a training image and setting information, and generates a task model 141.

The setting information is information used by the task learning unit 136 to learn the task model 141. The setting information is stored in a storage unit 120, for example. Alternatively, the setting information may be set by a user.

For example, the setting information includes information related to a configuration of the task model 141. For example, in a case where the task model 141 is a CNN, the setting information may include information related to a configuration of the neural network. Note that the task model 141 is not limited to the CNN as described above, and may have various configurations as long as being a model generated by supervised learning.

In a case where the task model 141 is generated for every plurality of tasks, the storage unit 120 stores the setting information for each of the task models 141.

Alternatively, the user sets the setting information for each of the task models 141. The setting information may be information that varies for every plurality of task models 141.

For example, the setting information includes target information related to target performance of the task model 141. For example, the target information includes a performance value (index value) to be achieved in the evaluation by an evaluation unit 133. This performance value is, for example, the same as an index value used for evaluation by the evaluation unit 133.

The task learning unit 136 outputs the generated task model 141 to the evaluation unit 133B. In addition, the task learning unit 136 stores the generated task model 141 in a task model DB 124.

The evaluation unit 133B evaluates the task model 141 on the basis of the task model 141 generated by the task learning unit 136 and an evaluation image. The evaluation unit 133B performs evaluation in a manner similar to that of the evaluation unit 133 in FIG. 1 except for a point that the task model 141 generated by the task learning unit 136 is evaluated instead of the learned task model 141 and that the evaluation is performed by utilization of the evaluation image instead of the training image for the evaluation.

The evaluation unit 133B acquires the evaluation image from an evaluation image DB 125, for example. The evaluation unit 133B outputs an evaluation result to an adjustment unit 134.

In a case where the evaluation result achieves the target performance set in advance or in a case where the number of times of evaluation reaches the maximum number of times of evaluation, the evaluation unit 133B ends the adjustment of the number of paths N and notifies the output unit 135B to perform a final output.

For example, the output unit 135B outputs a final training image and a final task model 143 as the final output on the basis of the instruction from the evaluation unit 133B. The final task model 143 is, for example, the task model 141 generated by the task learning unit 136 at a time point at which the evaluation unit 133B determines to perform the final output.

For example, every time the number of paths N is set, the task learning unit 136 relearns the task model 141 on the basis of the training image rendered by utilization of the number of paths N and the setting information. The task learning unit 136 outputs the repeatedly relearned task model 141 to the evaluation unit 133 and performs storing thereof in the storage unit 120. The output unit 135B outputs the latest task model 141 stored in the storage unit 120 as the final task model 143.

That is, the final task model 143 is the task model 141 that achieves the target performance or the task model 141 generated until the number of times of evaluation by the evaluation unit 133 reaches the maximum number of times of evaluation.

### <3.2. Configuration Example of the Information Processing Device>

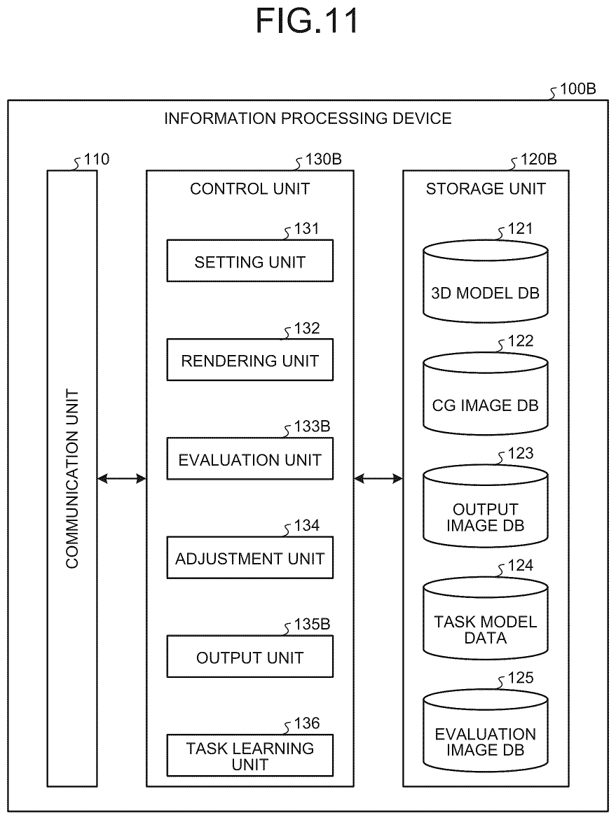

FIG. 11 is a block diagram illustrating a configuration example of the information processing device 100B according to the second embodiment of the present disclosure. The information processing device 100B illustrated in FIG. 11 is different from the information processing device 100 illustrated in FIG. 1 in a point that the control unit 130B includes the task learning unit 136, the evaluation unit 133B, and the output unit 135B. Furthermore, the information processing device 100B in FIG. 10 is different from the information processing device 100 illustrated in FIG. 1 in a point that a storage unit 120B includes the evaluation image DB 125.

### (Evaluation Image DB 125)

The evaluation image DB 125 is, for example, a database that stores the evaluation image used by the evaluation unit 133B to evaluate the task model 141. Examples of the evaluation image include a photographed image. Label information indicating Ground Truth may be given to the photographed image. Alternatively, the evaluation image may be a real (highly accurate) CG image. The label information indicating Ground Truth may be also given to the CG image.

### (Task Learning Unit 136)

The task learning unit 136 generates the task model 141 on the basis of a training image generated by a rendering unit 132 and the setting information. The task learning unit 136 outputs the generated task model 141 to the evaluation unit 133B and performs storing thereof in the task model DB 124. The task learning unit 136 generates the task model 141 for every plurality of tasks.

### (Evaluation Unit 133B)

The evaluation unit 133B evaluates the task model 141 on the basis of the task model 141 generated by the task learning unit 136 and the evaluation image stored in the evaluation image DB 125. The evaluation unit 133B evaluates the task model 141 on the basis of an output acquired in a case where the evaluation image is input to the task model 141.

### (Output Unit 135B)

For example, the output unit 135B outputs a final training image and a final task model 143 as the final output on the basis of the instruction from the evaluation unit 133B.

### <3.3. Adjustment Processing>

Next, adjustment processing executed by the information processing device 100B according to the second embodiment of the present disclosure will be described.

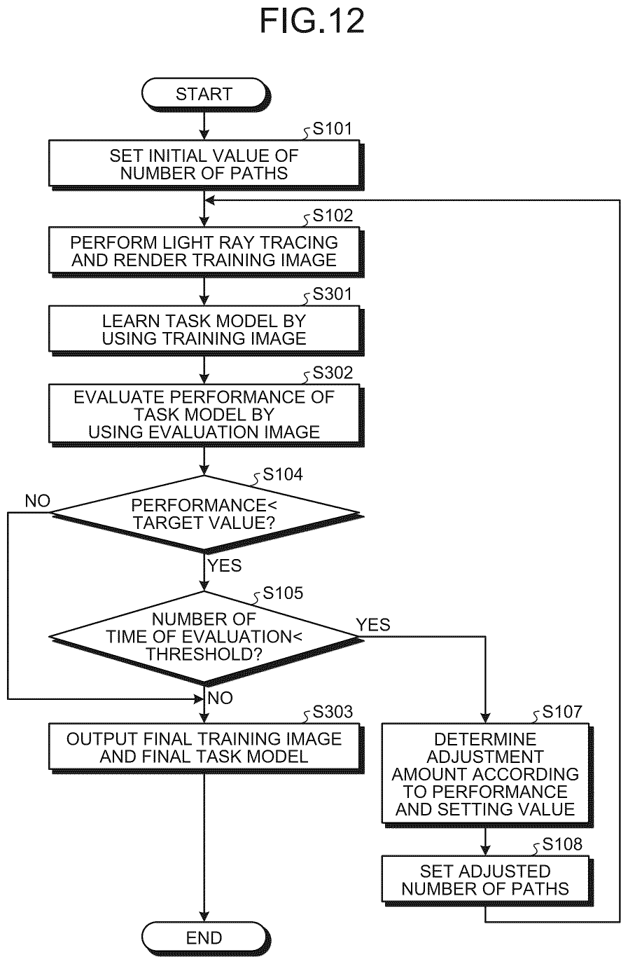

The information processing device 100B adjusts the number of paths N of rendering, and executes the adjustment processing of acquiring the final training image and the final task model 143. FIG. 12 is a flowchart illustrating a flow of an example of the adjustment processing executed by the information processing device 100B according to the second embodiment of the present disclosure. Among pieces of the processing illustrated in FIG. 12, the same processing as that in FIG. 7 is denoted by the same reference sign, and description thereof is omitted.

The information processing device 100B that renders the training image in Step S102 learns the task model 141 by using the training image (Step S301). The information processing device 100B uses the evaluation image and evaluates performance of the learned task model 141 (Step S302).

In addition, the information processing device 100A that determines in Step S104 that the performance is equal to or greater than a target value or determines in Step S105 that the number of times of evaluation is equal to or larger than a threshold outputs the final training image and the final task model 143, and ends the processing (Step S303).

As described above, the information processing device 100B generates the task model 141 by using the training image. As a result, the information processing device 100B can evaluate the performance of the task model 141 learned by utilization of the training image, and can generate the task model 141 satisfying the performance with the number of paths N of a smaller value.

### 4. Second Modification Example

### <4.1. Outline of an Information Processing Device>

Although the adjustment unit 134 of the information processing device 100A includes the learning unit 1341 and the prediction unit 1342 in the above-described first modification example, the adjustment unit 134 of the information processing device 100B may also include a learning unit 1341 and a prediction unit 1342 similarly.

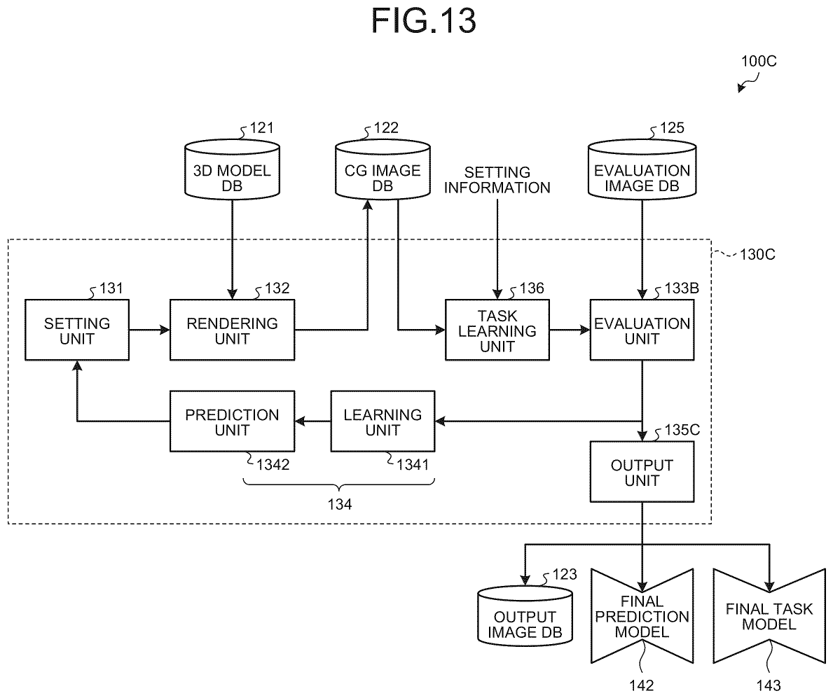

FIG. 13 is a view for describing a schematic configuration example of an information processing device 100C according to the second modification example of the second embodiment of the present disclosure. The information processing device 100C in FIG. 13 is different from the information processing device 100 illustrated in FIG. 10 in a point that an adjustment unit 134 of a control unit 130C includes a learning unit 1341 and a prediction unit 1342, and that the control unit 130C includes an output unit 135C instead of the output unit 135.

Similarly to FIG. 8, the learning unit 1341 performs machine learning by using an evaluation result of an evaluation unit 133 and a training image, and generates a prediction model that predicts the number of paths N. The learning unit 1341 outputs the prediction model after learning convergence to the prediction unit 1342. In addition, the learning unit 1341 stores the prediction model after the learning convergence in a storage unit 120.

Similarly to FIG. 8, the prediction unit 1342 predicts the number of paths N to be set next by using the prediction model learned by the learning unit 1341. For example, the prediction unit 1342 outputs the number of paths N of the prediction result to the setting unit 131 as an adjustment amount A.

Note that although it is assumed herein that the prediction unit 1342 predicts the number of paths N to be set next, this is not a limitation. For example, the prediction unit 1342 may predict an increase amount (or subtraction amount) of the number of paths N. In this case, the learning unit 1341 learns and generates the prediction model of predicting the increase amount (or subtraction amount) of the number of paths N.

For example, the output unit 135C outputs a final training image, a final prediction model 142, and a final task model 143 as final output on the basis of an instruction from an evaluation unit 133B.

### <4.2. Adjustment Processing>

Next, adjustment processing executed by the information processing device 100C according to the second modification example of the second embodiment of the present disclosure will be described.

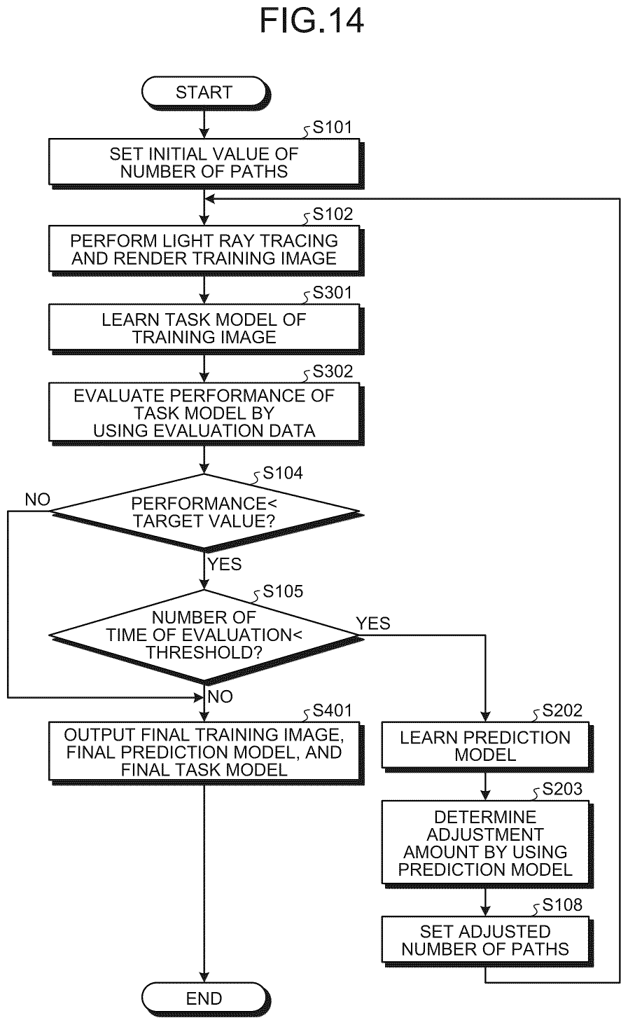

The information processing device 100A adjusts the number of paths N of rendering, and executes the adjustment processing of acquiring the final training image, the final prediction model 142, and the final task model 143. FIG. 14 is a flowchart illustrating a flow of an example of the adjustment processing executed by the information processing device 100C according to the second modification example of the second embodiment of the present disclosure. Among pieces of the processing illustrated in FIG. 14, the same processing as those in FIG. 7, FIG. 9, and FIG. 12 is denoted by the same reference sign, and description thereof is omitted.

As illustrated in FIG. 12, the information processing device 100C that determines in Step S104 that performance is equal to or greater than a target value or determines in Step S105 that the number of times of evaluation is equal to or larger than a threshold outputs the final training image, the final prediction model 142, and the final task model 143, and ends the processing (Step S401).

As described above, similarly to the first modification example, the information processing device 100C can predict the adjustment amount A by using machine learning by generating the prediction model that predicts the adjustment amount A.

### 5. Third Embodiment

### <5.1. Outline of an Information Processing Device>

In the first and second embodiments and the first and second modification examples described above, the information processing devices 100 and 100A to 100C adjust the number of paths N on the basis of the evaluation of the task model 141. However, this is not a limitation. For example, the information processing device 100 may adjust the number of paths N on the basis of a learned prediction model.

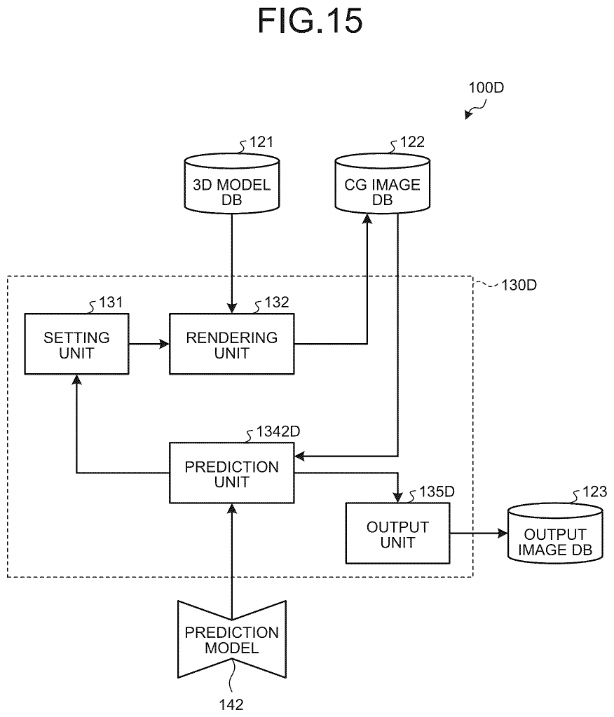

FIG. 15 is a view for describing a schematic configuration example of an information processing device 100D according to the third embodiment of the present disclosure. The information processing device 100D in FIG. 15 is different from the information processing device 100A illustrated in FIG. 8 in a point that a control unit 130D does not include the evaluation unit 133A and the learning unit 1341, and includes a prediction unit 1342D and an output unit 135D.

The prediction unit 1342D predicts the number of paths N to be set next by using a learned prediction model. Note that the prediction unit 1342D predicts the number of paths N and determines an adjustment amount A in a manner similar to that of the prediction unit 1342 illustrated in FIG. 8 and FIG. 13 except for a point that the learned prediction model is used.

Here, the learned prediction model may be, for example, the final prediction model 142 output by the output units 135A and 135B in the first and second modification examples. The learned prediction model does not need to be the final prediction model 142 and only needs to be a model that predicts the smaller number of paths N that satisfies performance of a task model 141.

The prediction unit 1342D ends an adjustment of the number of paths N according to the adjustment amount A or the adjusted number of paths N, and notifies the output unit 135D to perform final output.

The output unit 135D outputs a final training image on the basis of the instruction from the prediction unit 1342D.

### <5.2. Configuration Example of the Information Processing Device>

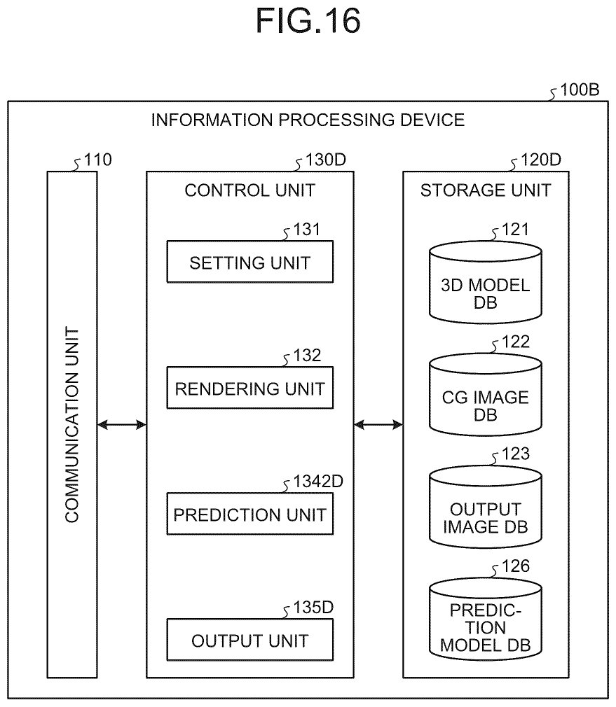

FIG. 16 is a block diagram illustrating the configuration example of the information processing device 100D according to the embodiment of the present disclosure. The information processing device 100D illustrated in FIG. 16 is different from the information processing device 100 illustrated in FIG. 6 in a point that the control unit 130D does not include the evaluation unit 133 and the adjustment unit 134 and includes the prediction unit 1342D and the output unit 135D. Furthermore, the information processing device 100D in FIG. 16 is different from the information processing device 100 illustrated in FIG. 6 in a point that a storage unit 120D includes a prediction model DB 126.

The prediction model DB 126 is, for example, a database that stores the learned prediction model.

The prediction unit 1342D determines the adjustment amount A by using the learned prediction model. In addition, in a case where a change amount of the number of paths N is equal to or smaller than a first threshold TH1, the prediction unit 1342D ends the adjustment of the number of paths N and notifies the output unit 135D to perform the final output. Alternatively, in a case where a cumulative amount of the number of paths N set by a setting unit 131 is equal to or larger than a second threshold TH2, the prediction unit 1342D ends the adjustment of the number of paths N and notifies the output unit 135D to perform the final output.

Note that in a case where the adjustment amount A is an increase amount or a subtraction amount of the number of paths N, the adjustment amount A is a change amount of the number of paths N.

For example, there is a case where the setting unit 131 sets the plurality of kinds of number of paths N, such as a case where the number of paths N is set for each of a plurality of training images or a case where the number of paths N is set for each pixel. In this case, the prediction unit 1342D determines to end the adjustment of the number of paths N in a case where an average value or a total value of change amounts in the plurality of kinds of number of paths N is equal to or smaller than the first threshold. Alternatively, in a case where the average value or the total value of the cumulative amount of the plurality of kinds of number of paths N is equal to or larger than the second threshold, the prediction unit 1342D determines to end the adjustment of the number of paths N.

### <5.3. Adjustment Processing>

Next, adjustment processing executed by the information processing device 100D according to the third embodiment of the present disclosure will be described.

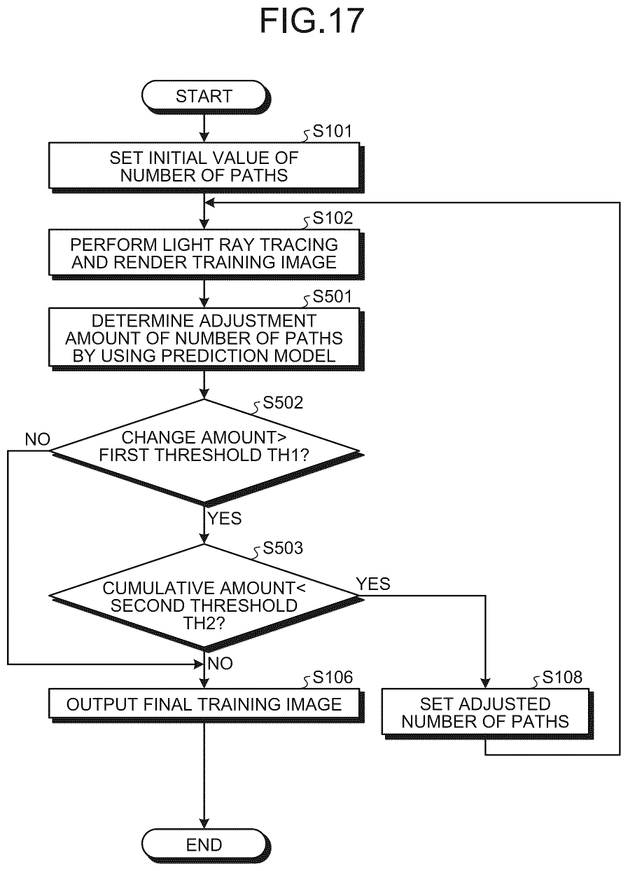

The information processing device 100D executes adjustment processing of adjusting the number of paths N of rendering and acquiring the final training image. FIG. 17 is a flowchart illustrating a flow of an example of the adjustment processing executed by the information processing device 100D according to the third embodiment of the present disclosure. Among pieces of the processing illustrated in FIG. 17, the same processing as that in FIG. 7 is denoted by the same reference sign, and description thereof is omitted.

The information processing device 100D that renders the training image in Step S102 determines the adjustment amount A of the number of paths N by using the learned prediction model (Step S501). The information processing device 100D inputs the training image to the learned prediction model and acquires a prediction result of the number of paths N. The information processing device 100D determines the adjustment amount A on the basis of the acquired prediction result of the number of paths N.

Next, the information processing device 100D determines whether the change amount of the number of paths N is larger than the first threshold TH1 (Step S502). In a case where the change amount is equal to or smaller than the first threshold TH1 (Step S502; No), the information processing device 100D proceeds to Step S106.

On the other hand, in a case where the change amount is larger than the first threshold (Step S502; Yes), the information processing device 100D determines whether the cumulative amount of the number of paths N is smaller than the second threshold TH2 (Step S503).

In a case where the cumulative amount is equal to or larger than the second threshold TH2 (Step S503; No), the information processing device 100D proceeds to Step S106. On the other hand, in a case where the cumulative amount is smaller than the second threshold TH2 (Step S503; Yes), the information processing device 100D proceeds to Step S108.

As described above, the information processing device 100D adjusts the number of paths N by using the learned prediction model. As a result, the information processing device 100D can acquire the training image in a shorter time.

### 6. Other Embodiments

Each of the above-described embodiments and modification examples is an example, and various modifications and applications can be made.

For example, the control device that controls the information processing device 100 of the first embodiment may be realized by a dedicated computer system or a general-purpose computer system.

For example, a communication program to execute the above-described operation is stored in a computer-readable recording medium such as an optical disk, a semiconductor memory, a magnetic tape, or a flexible disk and distributed. Then, for example, the program is installed in a computer and the above-described processing is executed, whereby the control device is configured. At this time, the control device may be a device (such as a personal computer) outside the information processing device 100. Furthermore, the control device may be a device (such as a control unit 130) inside the information processing device 100.

Furthermore, the communication program may be stored in a disk device included in a server device on a network such as the Internet in such a manner as to be downloadable to a computer. In addition, the above-described functions may be realized by cooperation of an operating system (OS) and application software. In this case, a portion other than the OS may be stored in a medium and distributed, or the portion other than the OS may be stored in a server device and downloaded to a computer.

Also, among the pieces of the processing described in each of the embodiments and the modification examples, a whole or part of the processing described to be automatically performed can be manually performed, or a whole or part of the processing described to be manually performed can be automatically performed by a known method. In addition, the processing procedures, specific names, and information including various kinds of data or parameters in the above document or in the drawings can be arbitrarily changed unless otherwise specified. For example, various kinds of information illustrated in each of the drawings are not limited to the illustrated information.

In addition, each component of each of the illustrated devices is a functional concept, and does not need to be physically configured in the illustrated manner. That is, a specific form of distribution/integration of each device is not limited to what is illustrated in the drawings, and a whole or part thereof can be functionally or physically distributed/integrated in an arbitrary unit according to various loads and usage conditions. Note that this configuration by distribution/integration may be performed dynamically.

Also, the above-described embodiments and modification examples can be arbitrarily combined in a region in which the processing contents do not contradict each other. In addition, order of steps illustrated in the flowcharts and the like of the above-described embodiments and modification examples can be appropriately changed.

Furthermore, for example, each of the embodiments and each of the modification examples can be implemented as any configuration included in a device or a system, such as a processor as system large scale integration (LSI) or the like, a module that uses a plurality of processors or the like, a unit that uses a plurality of modules or the like, a set acquired by further addition of other functions to the unit, or the like (that is, a configuration of a part of the device).

Note that a system means a set of a plurality of components (such as devices and modules (parts)) and it does not matter whether all the components are in the same housing in each of the embodiments and each of the modification examples. Thus, a plurality of devices housed in separate housings and connected via a network, and one device in which a plurality of modules is housed in one housing are both systems.

Furthermore, for example, each of the embodiments and each of the modification examples can adopt a configuration of cloud computing in which one function is shared and processed by a plurality of devices in cooperation via a network.

### 7. Conclusion

Although each of the embodiments and each of the modification examples of the present disclosure have been described above, the technical scope of the present disclosure is not limited to each of the above-described embodiments and modification examples, and various modifications can be made without departing from the gist of the present disclosure. In addition, components of different embodiments and modification examples may be arbitrarily combined.

Furthermore, an effect in each of the embodiments and each of the modification examples described in the present specification is merely an example and is not a limitation, and there may be another effect.

Note that the present technology can also have the following configurations.

(1)

An information processing device comprising:
a control unit that sets number of samples of a light ray used in a case where a rendered image is generated by utilization of ray tracing,
generates, by using the number of samples, the rendered image used as training data of machine learning, and
adjusts the number of samples in accordance with accuracy of a machine learning model of a case where the rendered image is learned as the training data and the number of samples used in generation of the rendered image.
   (2)

The information processing device according to (1), wherein the control unit adjusts the number of samples by using a prediction model of the number of samples.

(3)

The information processing device according to (2), wherein the control unit generates the prediction model of the number of samples according to the rendered image and an evaluation result of the accuracy.

(4)

The information processing device according to any one of (1) to (3), wherein the control unit adjusts the number of samples by using the machine learning model that is already learned.

(5)

The information processing device according to any one of (1) to (4), wherein the control unit generates the machine learning model by using the rendered image.

(6)

The information processing device according to any one of (1) to (5), wherein the control unit increases the number of samples in a case where the accuracy is lower than a target.

(7)

The information processing device according to any one of (1) to (6), wherein the control unit decreases the number of samples in a case where the accuracy is equal to or higher than a target.

(8)

The information processing device according to any one of (1) to (7), wherein the control unit adjusts the number of samples in such a manner that the number of samples becomes a smaller value in the number of samples with the accuracy being equal to or higher than a target.

(9)

The information processing device according to any one of (1) to (8), wherein the control unit sets the rendered image generated with the adjusted number of samples as output data.

(10)

The information processing device according to any one of (1) to (9), wherein the control unit adjusts the number of samples for each pixel of the rendered image.

(11)

The information processing device according to any one of (1) to (10), wherein the control unit adjusts the number of samples for all pixels of the rendered image.

(12)

The information processing device according to any one of (1) to (11), wherein the number of samples is number of samples in tracing using a Monte Carlo method.

(13)

An information processing method comprising:
setting number of samples of a light ray used in a case where a rendered image is generated by utilization of ray tracing;
generating, by using the number of samples, the rendered image used as training data of machine learning, and
adjusting the number of samples according to accuracy of a machine learning model of a case where the rendered image is learned as the training data and the number of samples used in generation of the rendered image.
   (14)

A program causing a computer to realize
setting number of samples of a light ray used in a case where a rendered image is generated by utilization of ray tracing,
generating, by using the number of samples, the rendered image used as training data of machine learning, and
adjusting the number of samples according to accuracy of a machine learning model of a case where the rendered image is learned as the training data and the number of samples used to generate the rendered image.

### REFERENCE SIGNS LIST

100, 100A, 100B, 100C, 100D INFORMATION PROCESSING DEVICE
110 COMMUNICATION UNIT
120, 120B, 120D STORAGE UNIT
121 3D MODEL DB
122 CG IMAGE DB
123 OUTPUT IMAGE DB
124 TASK MODEL DB
125 EVALUATION IMAGE DB
126 PREDICTION MODEL DB
130, 130A, 130B, 130C, 130D CONTROL UNIT
131 SETTING UNIT
132 RENDERING UNIT
133, 133A, 133B EVALUATION UNIT
134 ADJUSTMENT UNIT
135, 135A, 135B, 135C, 135D OUTPUT UNIT
136 TASK LEARNING UNIT
1341 LEARNING UNIT
1342, 1342D PREDICTION UNIT

1. An information processing device comprising:
a control unit that sets number of samples of a light ray used in a case where a rendered image is generated by utilization of ray tracing,
generates, by using the number of samples, the rendered image used as training data of machine learning, and
adjusts the number of samples in accordance with accuracy of a machine learning model of a case where the rendered image is learned as the training data and the number of samples used in generation of the rendered image.

2. The information processing device according to claim 1, wherein the control unit adjusts the number of samples by using a prediction model of the number of samples.

3. The information processing device according to claim 2, wherein the control unit generates the prediction model of the number of samples according to the rendered image and an evaluation result of the accuracy.

4. The information processing device according to claim 1, wherein the control unit adjusts the number of samples by using the machine learning model that is already learned.

5. The information processing device according to claim 1, wherein the control unit generates the machine learning model by using the rendered image.

6. The information processing device according to claim 1, wherein the control unit increases the number of samples in a case where the accuracy is lower than a target.

7. The information processing device according to claim 1, wherein the control unit decreases the number of samples in a case where the accuracy is equal to or higher than a target.

8. The information processing device according to claim 1, wherein the control unit adjusts the number of samples in such a manner that the number of samples becomes a smaller value in the number of samples with the accuracy being equal to or higher than a target.

9. The information processing device according to claim 1, wherein the control unit sets the rendered image generated with the adjusted number of samples as output data.

10. The information processing device according to claim 1, wherein the control unit adjusts the number of samples for each pixel of the rendered image.

11. The information processing device according to claim 1, wherein the control unit adjusts the number of samples for all pixels of the rendered image.

12. The information processing device according to claim 1, wherein the number of samples is number of samples in tracing using a Monte Carlo method.

13. An information processing method comprising:
setting number of samples of a light ray used in a case where a rendered image is generated by utilization of ray tracing;
generating, by using the number of samples, the rendered image used as training data of machine learning, and
adjusting the number of samples according to accuracy of a machine learning model of a case where the rendered image is learned as the training data and the number of samples used in generation of the rendered image.
